(19) United States
(12) Patent Application Publication
(10) Pub. No.: US 2002/0047304 A1
(43) Pub. Date: Apr. 25, 2002

(54) Pressure sensor integrated onto sleeve of solenoid valve

(76) Inventors: Marc Bolitho, Linden, MI (US); Michael Babala, Plymouth, MI (US); Thomas Baron, Leimbach (DE); Helmut Gegalski, Muhlheim-Karlich (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/908,462

(22) Filed: Jul. 18, 2001

Related U.S. Application Data
(60) Provisional application No. 60/218,860, filed on Jul. 18, 2000.

(51) Int. Cl. B60T 8/36

(52) U.S. Cl. 303/119.2; 303/119.1

(57) ABSTRACT

A pressure sensor is integrated upon a solenoid valve by attaching at least one micro-machined strain gauge to an end of the solenoid valve sleeve. The solenoid valve is included in a vehicle brake control system. As the hydraulic fluid pressure in the brake system changes, the end of the solenoid valve sleeve is deflected, causing a change in an electrical property of the strain gauge. The stain gauge is included in a bridge circuit that is electrically connected to a signal conditioning circuit. The signal conditioning circuit generates a pressure signal that is a function of the change in the electrical property of the strain gauge.

### CROSS REFERENCE TO RELATED APPLICATIONS

This application claims the benefit of U.S. Provisional Application No. 60/218,860, filed Jul. 18, 2000.

### TECHNICAL FIELD

This invention relates to an electro-hydraulic control unit for a vehicle brake system. More specifically, this invention relates to a pressure sensor attached to a solenoid valve that is included in an electro-hydraulic control unit.

### BACKGROUND OF THE INVENTION

Many vehicles being currently produced by automotive manufacturers include automatic control systems that are integrated with their hydraulic brake systems. Such systems include Vehicle Stability Control (VSC) systems that prevent loss of directional control of a vehicle during vehicle manueveurs. A VCS system typically includes an Anti-lock Brake System (ABS) and Traction Control (TC).

In a conventional hydraulic brake system, movement of the brake pedal, connected to a master cylinder, causes a piston within the master cylinder to move. This movement forces pressurized hydraulic fluid throughout the brake system and into cylinders located at each wheel. The hydraulic fluid causes displacement of a brake piston located within each of the brake cylinders. Movement of the brake piston either urges a brake pad against a disc or a brake shoe against a brake drum. The resulting friction between components brakes the wheel.

A VSC system includes an electro-hydraulic control unit that is integrated with the brake lines of the hydraulic brake system. The electro-hydraulic control unit typically includes an Electronic Control Unit (ECU) which is mounted upon a hydraulic valve body. The ECU includes a microprocessor and control algorithm for operating the VSC system. A plurality of solenoid valves are disposed within the hydraulic valve body. The solenoid valves can include normally open isolation valves and normally closed dump valves. The ECU is connected to the solenoid valves and one or more wheel speed sensors. A pump also is mounted upon the hydraulic valve body to supply pressurized brake fluid to the VSC system. The pump is controlled by the ECU microprocessor. During vehicle operation, the ECU microprocessor continuously receives speed signals from the wheel speed sensors.

When the microprocessor senses an impending loss of vehicle directional control, the VSC system is activated. The ECU microprocessor starts the pump to supply pressurized brake fluid and causes the solenoid valves to cyclically apply and relieve hydraulic pressure to the wheel brakes to correct the direction of the vehicle.

An VSC system also includes pressure sensors. Pressure sensors measure pressure inside the solenoid valves, as well as pressure at the brakes or master cylinder. One or more pressure sensors are attached to the ECU. Data from the pressure sensor is sent to the ECU microprocessor which, in turn, uses the pressure data to control flow of the brake fluid through the solenoid valves by displacing their armatures. The pressure sensor is typically housed in a pressure sensor unit, a structure separate from the solenoid valve.

Pressure sensors typically include a strain gauge. The strain gauge is usually mounted upon a flexible metallic diaphragm carried by a pressure sensor housing. The pressure sensor housing is mounted upon an end of a bore formed in the hydraulic valve body. The bore communicates with a chamber containing brake fluid under pressure. The strain gauge is usually integrated into a bridge circuit of a type well known in the art. As the pressure in the chamber increases, the pressure within the pressure sensor housing also increases and the diaphragm deflects. The deflection of the diaphragm stretches the strain gauge which changes an electrical property of the strain gauge. The change in the electrical property is proportional to the applied pressure. Signal conditioning circuitry connected to the bridge circuit converts the change in the electrical property to a pressure signal which is transmitted to the ECU microprocessor.

### SUMMARY OF THE INVENTION

This invention relates to a pressure sensor attached to a solenoid valve that is included in an electro-hydraulic control unit.

As described above, it is known to include pressure sensors in hydraulic brake control systems. However, such sensors require a housing that takes up space and needs to be attached to a bore formed in a hydraulic valve body. Accordingly, it would be desirable to combine a pressure sensor with a solenoid valve to reduce the size of the electro-hydraulic valve unit while reducing the number of bores formed in the hydraulic valve body.

The present invention is directed toward a solenoid valve that includes a cylindrical valve sleeve having an open end with a diaphragm across the open end of the sleeve. At least one strain gauge is mounted upon the diaphragm. Deflection of the diaphragm changes an electrical property of the strain gauge.

The pressure sensor can include a cup-shaped end cap attached to the open ended sleeve. The end cap includes a surface that extends across the open end of the sleeve to form the diaphragm with the strain gauge mounted upon the end cap diaphragm. In the preferred embodiment, the strain gauge is a micro-machined strain gauge that is glass bonded to the diaphragm. The strain gauge is included in a bridge circuit that is connected to a signal conditioning circuit. The signal conditioning circuit generates a pressure signal that is a function of the change in the electrical property of the strain gauge.

Alternately, the valve sleeve can be formed as a one piece closed end tube with the closed end forming a diaphragm. The strain gauges are mounted upon the diaphragm as described above.

It is contemplated that the integrated pressure sensor and solenoid valve is utilized in a vehicle brake control system to measure hydraulic brake fluid pressure.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is cross-sectional view of a portion of an solenoid valve in accordance with the invention.

FIG. 2 is a perspective view of an end of the solenoid valve shown in FIG. 1.

FIG. 3 is a cross-sectional view of an alternated embodiment of the isolation valve shown in FIG. 1.

FIG. 4 is a perspective view of the isolation valve shown in FIG. 3.

FIG. 5 is a cross-sectional view of another alternate embodiment of the isolation valve shown in FIG. 1.

### DETAILED DESCRIPTION OF THE INVENTION

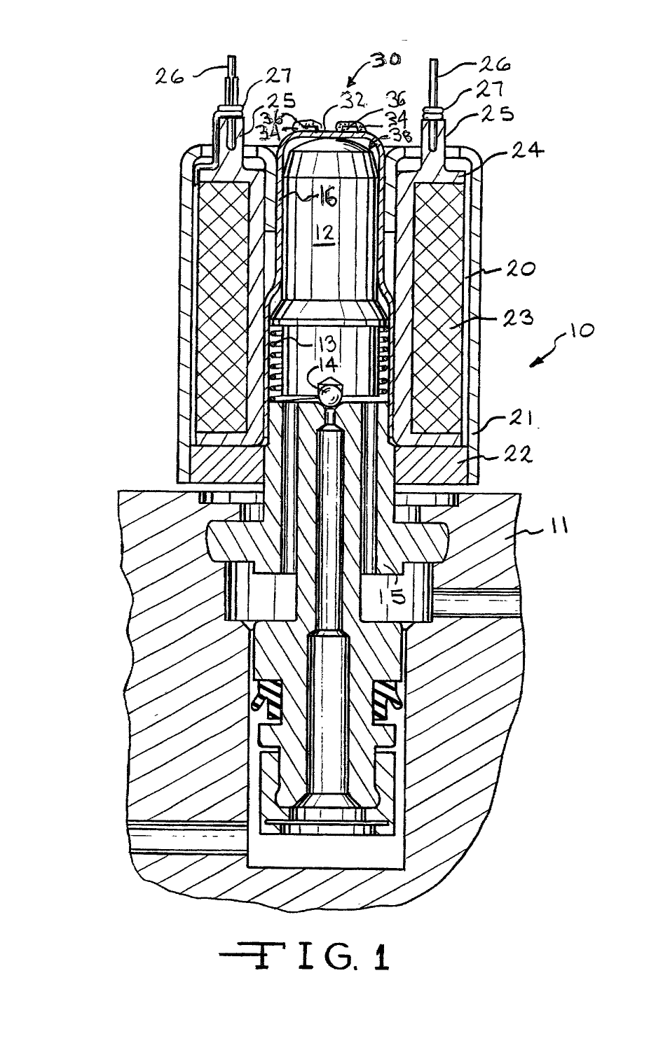

Preliminarily, it should be noted that certain terms used herein, such as “lower”, and “upper” are used to facilitate the description of the preferred embodiment of the invention. Unless otherwise specified or made apparent by the context of the discussion, such terms should be interpreted with reference to the figure under discussion. The term “upper” should be taken to mean the portion of the component under discussion which is most distant from the valve body when the components of the invention are oriented in the arrangement shown in FIG. 1. Similarly, the term “lower” should be taken to mean the portion of the component under discussion which is closest to the valve body when the components of the invention are oriented in the arrangement shown in FIG. 1. Such terms are not intended as a limitation on the position in which the components of the invention may be used.

Referring now to FIG. 1, there is shown a sectional view of a solenoid valve 10 in accordance with the invention. The solenoid valve 10 is mounted upon a hydraulic valve body 11. The valve 10 includes an axially shiftable armature 12 which is biased in an upward direction by a spring 13 such that a ball valve, generally represented by a reference numeral 14, is maintained in a normally open position. The ball valve 14 cooperates with a valve seat member 15 which is mounted in the valve body 11. The armature 12 is slideably disposed within a valve sleeve 16 having a closed end. A solenoid coil 20 is carried by the valve sleeve 16 and surrounds the armature 12. The coil 20 is enclosed by a metal flux return casing 21. An annular flux ring 22 is disposed within the open end of the flux casing 21. The flux return casing 21 and flux ring 22 complete a magnetic flux path which passes through the armature 12 and the valve seat member 15.

The solenoid coil 20 is of conventional design, comprising a winding 23 formed from multiple turns of an insulated magnet wire having a round cross section. The coil wire is helically wound upon a plastic bobbin 24. A pair of terminal pin supports 25 extend in an axial direction from the top of the bobbin 24. Each of the supports 25 is molded over a terminal pin 26. An end 27 of the coil winding wire is wound around the base of each of the terminal pins 26 and soldered thereto. The pins 26 are electrically coupled to the brake control system microprocessor.

When it is necessary to actuate the valve 10 during an anti-lock braking cycle, an electric current is supplied through the terminal pins 26 to the coil 20. The current establishes a magnetic field in the armature 12 which pushes the armature 12 in a downward direction, closing the ball valve 14. When the current is interrupted, the magnetic field collapses, allowing the spring 13 to return the armature 12 to its original position, thereby reopening the ball valve 14. Hence the solenoid valve 10 illustrated in FIG. 1 is configured as a normally open, or isolation, valve.

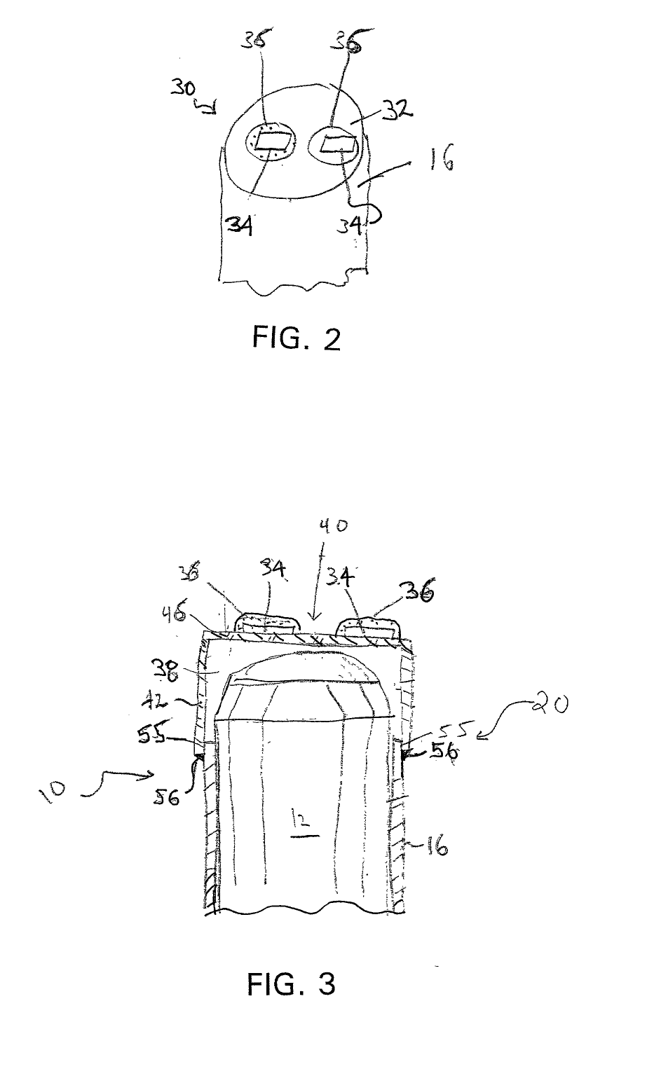

As best seen in FIG. 2, a pressure sensor 30 is integrated onto the upper end surface of the valve sleeve 16 in accordance with the invention. The upper end surface of the valve sleeve 16 forms a diaphragm 32 for the pressure sensor 30. In the preferred embodiment, the valve sleeve 16, and hence the diaphragm 32, are formed from stainless steel. Strain gauges 34 are positioned upon the diaphragm 32. A preferred embodiment, as illustrated n FIGS. 2 and 3, includes two strain gauges 34; however, the invention can be practiced with one strain gauge (not shown) or more than two strain gauges (not shown). A gauge cover 36 is positioned over the strain gauges 34. The gauge cover 36 is preferably formed from glass, but can be any other suitable material. The purpose of the gauge cover 36 is to insulate and protect the strain gauges 34. In the preferred embodiment, micro-machined strain gauges are glass bonded to the upper end surface of the valve sleeve 16. The glass bonding material can totally enclose the strain gauges 34 to provide the protective and insulative cover described above.

The strain gauges 34 are included in a conventional bridge circuit (not shown), such as, for example, a full or half bridge circuit. The bridge circuit is connected to a signal conditioning circuit (not shown). The signal conditioning circuit is connected to an ECU microcontroller (not shown).

The operation of the pressure sensor 30 will now be described. The valve armature 12 is shaped to allow brake fluid to flow past the armature 12 and into a chamber 38 formed within the upper portion of the valve sleeve 16 between the armature 12 and the diaphragm 32. Thus, the chamber 32 contains brake fluid under pressure. When the vehicle operator depresses the brake pedal, increased brake fluid pressure causes the diaphragm 32 to deflect in an upward direction in FIG. 1. The deflection of the diaphragm 32 deforms the strain gauges 34 and thereby changes an electrical property of the gauges 34. The specific property is determined by the type of strain gauge. For example, with strain gauges formed from a piezoelectric material, the voltage appearing across the stain gauge will change as the gauge is deformed. The signal conditioning circuit converts the change in the electrical property of the strain gauges 34 into a brake fluid pressure signal. The pressure signal is transmitted to the ECU microprocessor. The ECU uses the pressure signal to control flow of the brake fluid through the solenoid valves 10 by displacing the solenoid valve armatures 12. For the isolation valve 10 shown in FIG. 1, the strain gauges 34 measure the master cylinder pressure while the valve 10 is open. Upon closure of the valve 10, the stain gauges 10 measure the pressure within the wheel cylinder that is connected to the isolation valve 10.

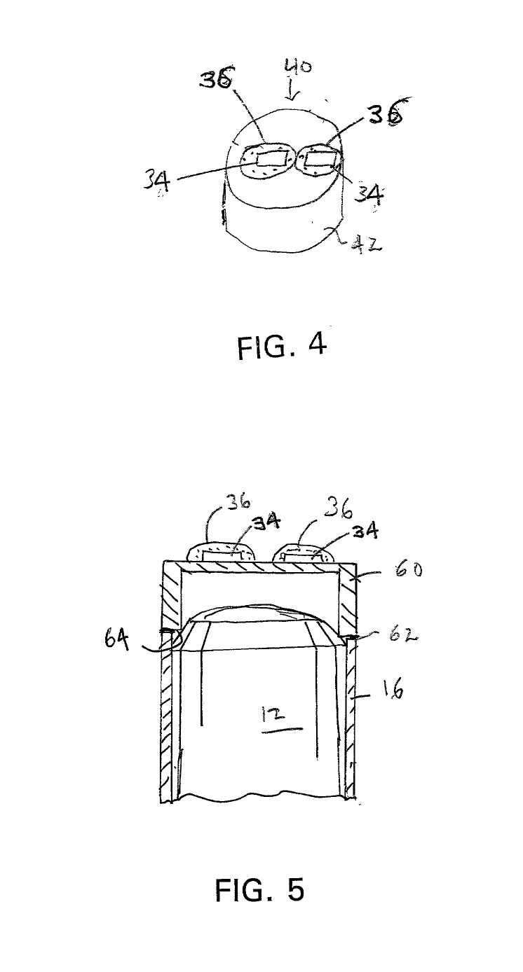

Referring now to FIGS. 3 and 4, an alternate embodiment of a pressure sensor 40 integrated onto a valve sleeve 41 in accordance with the invention is shown. Components shown in FIGS. 3 and 4 that are similar to components shown in FIGS. 1 and 2 have the same numerical designators. The pressure sensor 40 includes a cylindrical end cap 42 for the valve sleeve 16. The end surface of the cap 42 forms a diaphragm 46 for the pressure sensor 40. Strain gauges 34 are positioned upon the diaphragm 46. A preferred embodiment includes two micromachined strain gauges 34 that are glass bonded to a stainless steel cap 42. While two strain gauges 34 are shown in FIG. 3, it will be appreciated the invention also can be practiced with one strain gauge (not shown) or more than two strain gauges (not shown). The bonding glass encases the strain gauges 34 to insulate and protect the strain gauges 34. As described above, the strain gauges 34 are included in a conventional bridge circuit (not shown) that is connected to a signal conditioning circuit (not shown). The bridge circuit can have either a conventional full or half bridge configuration. The signal conditioning circuit is electrically connected to an ECU microprocessor (not shown).

In a preferred embodiment, the cap 40 is attached to the valve sleeve 16, at an attachment areas 55. The attachment area 55 can be at any portion of the cap 40 and any portion of the valve sleeve 16. As shown in FIG. 3, the lower edge of the cap 40 extends over the upper end of the sleeve 16. In the preferred embodiment, the cap 40 is secured to the sleeve 16 by a conventional welding process, such as, for example laser or friction welding. A circumferential weld 56 is formed to assure that brake fluid does not leak from between the cap 42 and the valve sleeve 16. It is also contemplated that the cap 42 can be press fit or crimped onto the sleeve end; however, the atachment must both seal the joint between the sleeve 16 and the cup 42 and have enough strength to retain the cup 42 in place on the end of the sleeve 16 when subjected to the hydraulic brake pressure during a brake application.

The cap 40 and the end of the valve sleeve 16 cooperate to form a chamber 38 that contains brake fluid under pressure. The upper end of the chamber 38 is enclosed by the cap 42. As described above, when the vehicle operator depresses the brake pedal, the diaphragm 46 deflects in an upward direction in FIG. 3. The deflection of the diaphragm 46 changes an electrical property of the stain gauges 34 mounted upon the diaphragm 46. Also as described above, the change in electrical property of the strain gauges 34 is converted to a pressure signal by the signal conditioning circuitry and then transmitted to the ECU microprocessor.

Another alternate embodiment of the pressure sensor is illustrated in FIG. 5. As before, components shown in FIG. 5 that are similar to components shown in the previous Figures have the same numerical designators. As shown in FIG. 5, a pair of strain guages 34 are mounted upon an end cap 60. In the preferred embodiment, micro-machined strain gauges 34 are secured with glass bonding 36 a diaphragm 61 formed by the end surface of the cap 60. While two strain gauges 34 are shown in FIG. 5, it will be appreciated that the invention also can be practiced with one strain gauge (not shown) or more than two strain gauges (not shown).

The end cap 60 has a smaller diameter than the end cap 42 shown in FIG. 3. Accordingly, a butt joint is formed between the lower edge of the cap 60 and the upper end of the valve sleeve 16. A circumferential weld 62 secures the end cap 60 to the end of the valve sleeve and provides a seal therebetween to prevent any leakage of hydraulic brake fluid. As also shown in FIG. 5, the inside diameter of the end cap 60 is less than the inside diameter of the valve sleeve 16 and defines a stop 64 that limits the axial travel of the valve armature 12 within the sleeve 16. Alternately, the inside diameter of the cap 60 can be the same as that of the sleeve 16, in which case, the axial motion of the armature 12 is only limited by the inner surface of the diaphragm formed by the cap 60.

It will be appreciated that there are a number of specific ways to combine or configure the diaphragm with the strain gauge. For example, a silicon strain gauge can be bonded with glass to a stainless steel diaphragm. Also, a NiCr thin film strain gauge can also be bonded with glass to a stainless steel diaphragm. Similarly, the strain gauge can be sealed in a fluid filled cavity and mounted on the diaphragm (not shown). In such a configuration, pressure is transferred from the diaphragm to the strain gauge through the fluid in the cavity.

The invention provides a number of improvements over prior art pressure sensors. Combining the pressure sensor with a solenoid valve eliminates the need to provide a separate port in the hydraulic valve body for a pressure sensor. This not only reduces manufacturing costs, but also reduces potential leaks of hydraulic fluid. Elimination of a separate pressure sensor with a housing reduces the package size of the electro-hydraulic control unit. Assembly of the electro-hydraulic control unit is simplified since a pressure sensor does not need to be installed in the hydraulic valve body. Additionally, the electrical connection of the pressure sensor would be included with the electrical connector for the solenoid coil associated with the valve. This is expected to simplify assembly and reduce tolerances.

The principle and mode of operation of this invention have been described in its preferred embodiments. However, it should be noted that this invention may be practiced otherwise than as specifically illustrated and described without departing from its scope. For example, the invention can be applied to dump valves and supply valves in addition to isolation valves. Likewise, the invention can be included in Hydraulic Brake Assist (HBA) applications in addition to VSC applications.

What is claimed is:

1. A pressure sensor comprising;
an open ended cylindrical sleeve;
a diaphragm across one end of said cylindrical sleeve;
at least one strain gauge mounted upon said diaphragm whereby deflection of said diaphragm changes an electrical property of said strain gauge.

2. The pressure sensor of claim 1 further including a cup-shaped end cap attached to said open ended sleeve, said end cap including a surface that extends across said open end of said sleeve to form said diaphragm with said strain gauge mounted upon said end cap diaphragm.

3. The pressure sensor of claim 2 wherein said end cap is welded to said open end of said sleeve.

4. The pressure sensor of claim 2 wherein said sleeve is included in a solenoid valve having a moveable armature, said armature being disposed within said sleeve.

5. The pressure sensor of claim 4 wherein said strain gauge is a micromachined strain gauge that is glass bonded to said diaphragm.

6. The pressure sensor of claim 5 wherein said pressure sensor measures the pressure of a hydraulic brake fluid.

7. The pressure sensor of claim 6 wherein said strain gauge is included in a bridge circuit.

8. The pressure sensor of claim 7 wherein said bridge circuit is connected to a signal conditioning circuit.

9. The pressure sensor of claim 8 wherein said bridge circuit is connected to a signal conditioning circuit that generates a pressure signal that is a function of said change in said electrical property of said strain gauge.

10. The pressure sensor of claim 9 wherein said solenoid valve is included in vehicle brake control system.

11. The pressure sensor of claim 10 wherein said vehicle brake control system is a vehicle stability control system.

12. A pressure sensor comprising:
a closed ended cylindrical sleeve, said sleeve including a cylindrical portion and a disc-shaped end portion extending across said sleeve, said end portion forming a diaphragm; and
at least one strain gauge mounted on said diaphragm whereby deflection of said diaphragm changes an electrical property of said strain gauge.

13. The pressure sensor of claim 12 wherein said sleeve is included in a solenoid valve having a moveable armature, said armature being disposed within said sleeve.

14. The pressure sensor of claim 13 wherein said strain gauge is a micromachined strain gauge that is glass bonded to said diaphragm.

15. The pressure sensor of claim 14 wherein said strain gauge is included in a bridge circuit.

16. The pressure sensor of claim 15 wherein said bridge circuit is connected to a signal conditioning circuit that generates a pressure signal, said pressure signal being a function of said change in said electrical property of said strain gauge.

17. The pressure sensor of claim 16 wherein said bridge circuit is connected to a signal conditioning circuit.

18. The pressure sensor of claim 17 wherein said solenoid valve is included in vehicle brake control system and measures hydraulic brake fluid pressure.

19. A solenoid valve comprising:
a valve body that includes a valve seat;
a cylindrical sleeve having a closed end attached to said valve body;
a movable armature disposed within said sleeve, said armature carrying a valve ball;
a spring disposed within said sleeve, said spring urging said armature in an axial direction within said sleeve;
a solenoid coil disposed about said sleeve; and
at least one strain gauge attached to said closed end of said sleeve whereby deflection of said closed end of said sleeve causes a change of an electrical characteristic of said strain gauge.

20. The solenoid valve of claim 19 wherein said stain gauge is a mircro-machined strain gauge that is glass bonded to said closed end of said sleeve.

21. The solenoid valve of claim 20 wherein said strain gauge is included in a bridge circuit.

22. The solenoid valve of claim 21 wherein said bridge circuit is connected to a signal processing circuit that generates a pressure signal that is a function of said change in said electrical property of said strain gauge.

23. The solenoid valve of claim 22 wherein the valve is included in a vehicle brake control system.

24. The solenoid valve of claim 23 wherein said sleeve includes a cylindrical portion with a cup-shaped end cap attached to one end thereof, said end cap including an end portion with said strain gauge attached to said end portion.
